(19) United States
(12) Patent Application Publication
(10) Pub. No.: US 2011/0038159 A1
(43) Pub. Date: Feb. 17, 2011

(54) Metal Lights

(76) Inventor: Jerry Carlson, Fort Worth, TX (US)

Correspondence Address: WILSON DANIEL SWAYZE, JR., 3804 CLEARWATER CT., PLANO, TX, 75025, US

(21) Appl. No.: 12/176,349

(22) Filed: Jul. 19, 2008

(51) Int. Cl. F21V 21/096

(52) U.S. Cl. 362/249.16

(57) ABSTRACT

A string of detachably connected lights may include a first light being magnetically detachably connected to a magnetic surface and a second light being magnetically detachably connected to the magnetic surface and being electrically connected to the first light. The first light may include a first filament, and the second light may include a second filament. The first light may include a first light base member, and the second light may include a second light base member. The first light may include a first magnetic housing member, and the second light may include a second housing member. The first housing member may include a first magnetic enclosure portion, and the second magnetic housing member may include a second magnetic enclosure portion. The first magnetic housing member may include a first magnet.

### FIELD OF THE INVENTION

The present invention relates to Christmas lights and more particularly to a method and apparatus for attaching magnetically the Christmas lights to a house or other object.

### BACKGROUND OF THE INVENTION

Each year, the owners of a homes and establishments expend a great deal of expense and time in order to decorate the home or establishment with Christmas lights. In recent years, the number of lights that have been used to decorate homes and establishments has steadily increased. Unfortunately, the amount of work and expense needed to install and remove these Christmas lights have correspondingly increased. Generally, each bulb of a string of Christmas lights has to be individually secured to the side of the house or establishment. The number of Christmas lights can reach into the hundreds and maybe thousands which results in a large amount of time to install these lights. Furthermore, at the end of the Christmas season, the lights must be taken down. Consequently, each Christmas light must be individually detached from the home.

A variety of methods and related apparatus have been developed for the purpose of suspending christmas lights from eaves on a house. All of these methods and related apparatus are to some extent deficient. Each “string” of christmas lights consists of a plurality of sockets, into which light bulbs are inserted, connected by a shielded electrical cord. One method involves suspending the christmas lights from an eaves trough on a house. A variety of specially designed clips have been developed for this purpose. These clips suspend the christmas lights from the outer most peripheral edge of the eaves trough. The best functioning clip developed for this purposes has a generally “U” shaped gripping portion which grips the sockets such that the light bulbs are suspended in parallel spaced relation to the eaves trough. This clip has a number of deficiencies. The light bulbs and cord vibrate against the eaves when exposed to strong winds, which often damages the delicate filaments in the light bulbs. The clip and the cord are clearly visible from the sidewalk, detracting from the aesthetics of the light display. The cord and bulbs are directly exposed to ultra violet rays of the sun which, over time, causes their deterioration. The cord is suspended in the eaves trough, which sometimes leads to blockage of the eaves trough. Another method of suspending the christmas lights from the eaves of on a house involves using “tabs” which are inserted under the shingles. This method is unsightly as a large portion of the tab as well as the light cord and socket remain visible. In addition, there are functional deficiencies as the tabs which suspend the lights are extremely prone to vibration when exposed to strong winds and suspend the lights at an angle. The tabs tend to deteriorate due to constant exposure to the elements, including the effects of the ultra violet rays of the sun and exposure to snow, sleet and the like. Another method involves using a permanent clip which is attached to the house by means of nails or screws. These permanent clips are always visible, and upon removal scar the exterior finish of the house. Over time, the nails or screws used to attach the clips rust.

U.S. Pat. No. 7,188,977 discloses a gutter interface device for facilitating hanging of Christmas lights from a gutter. The gutter interface device includes a gutter interface portion and a cord interface portion. The gutter interface portion has a main vertical member for abutting a front edge of the gutter. The gutter interface portion has a lip-engaging member integrally coupled to the main vertical member. The lip-engaging member has a first horizontal extent coupled to the main vertical member, a vertical extent and a second horizontal extent, said lip-engaging member being u-shaped for abutting three sides of a lip of a gutter.

U.S. Pat. No. 6,409,364 discloses a fastening device for a Christmas light which includes a socket of a conventional type having a notch in a circumferential wall of the bottom. A cap engaged with the bottom of the socket having a narrow portion on the root of a projection facing to the notch of the socket. A separating fastener of L-shaped section having a jaw engageable with the narrow portion of the projection through the notch, a first clip defined between the socket and the lower portion of the fastener and a second clip defined by an extension and the outer surface of the first clip. Both the first and second clips have a serrated portion on their inner surfaces in order to firmly attach the Christmas light to a flat or linear object.

U.S. Pat. No. 6,267,342 discloses an attachable cord holder for a Christmas light which includes an arcuate plate slidably inserted into a pair guide slots behind rectangular notch in the top of a socket of the light, a hook of roughly U-shaped section connected to the arcuate plate having a narrow entrance into the top and a thumbpiece extended outward from a flange of a base of the light having a round surfaced protrusion projected downward from the free end and engageable with the entrance of the hook. When a cord is transversely disposed into the hook, the round surfaced protrusion of the thumbpiece is pressed downward and frictionally inserted into the entrance of the hook to tightly close the entrance.

U.S. Pat. No. 5,913,600 discloses a Christmas light suspensible from more than one linear object. The light includes a tubular receptacle including a hollow interior with contact plates and a partition therein for receiving a base of a lamp which includes a pair of contact wires and a central notch respectively engageable with the contact plates and the partition of the receptacle, a pair electrical wires connected to the contact plates and extended out of the receptacle through a pair of longitudinal apertures and an elongate notch centrally formed in a rear end of the receptacle between the apertures including a hook of triangular section at the opening of the notch so as to define a slope narrow entrance for the notch.

U.S. Pat. No. 5,769,535 discloses a portable light lamp having multiple brightness providing predominantly directed light projection. The portable light employs a light source and a light source housing, the light source housing having a directed light port disposed to project light from the light source therethrough in a selected direction at a first brightness and at least one filtered light port to project light from the light source therethrough in another direction at a second brightness which is diminished from the first brightness. One or more magnets are secured to the side of the light source housing to attach the portable light to magnetic material.

U.S. Pat. No. 5,501,342 discloses a magnetic socket track which is provided a non-ferrous base with concave grips the length of the outer sides. Two sections of ferrous metal with ninety (90) degree bends lie inside the channel with the protrusion of the ninety (90) degree bends facing each other. Set between the ferrous metal strips lies a length of conventional magnetic material with the north pole facing one metal strip and the south pole facing the other, yet set far enough from the ninety (90) degree bends to provide a channel. Due to the relationship of the magnetic material and the ferrous metal, a strong magnetic field is formed at the ninety (90) degree bends and right angle material. Into this channel slide the square or hexagonal heads of the threaded non-ferrous studs, with the heads of the studs large enough to prevent the studs from rotating in the channel. Numerous studs are positioned in the channel with various sizes of non-ferrous, round, internally-threaded receptacles tightened down on the studs. The receptacles receive sockets with corresponding drive sizes. The sockets are placed over the receptacles and are held in place by magnetic energy. The round receptacles keep the sockets from being jarred off the track and also holds their precise location for return to the magnetic track after use.

U.S. Pat. No. 5,141,192 discloses a method of suspending christmas lights underneath eaves of a house finished with aluminum or vinyl soffit panels and facia. Firstly, attach a plurality of wedge shaped members to a string of christmas lights. Secondly, insert the wedge shaped members between facia and soffit of a house. The christmas lights protrude perpendicularly below the facia and are clearly visible from an adjacent street while the wedge shaped members and light cord remain substantially hidden from view by the facia

U.S. Pat. No. 5,024,406 discloses a hanging outdoor christmas light holder for a lamp socket fixture and a removably attaching member having a first component that is permanently attachable to a static structure on a building, while a second mating component is carried on underside of the lamp socket fixture so that the lamp socket fixture can be quickly and simply attached thereto and removed therefrom.

### SUMMARY

A string of detachably connected lights may include a first light being magnetically detachably connected to a magnetic surface and a second light being magnetically detachably connected to the magnetic surface and being electrically connected to the first light.

The first light may include a first filament, and the second light may include a second filament.

The first light may include a first light base member, and the second light may include a second light base member.

The first light may include a first magnetic housing member, and the second light may include a second housing member.

The first housing member may include a first magnetic enclosure portion, and the second magnetic housing member may include a second magnetic enclosure portion.

The first magnetic housing member may include a first magnet.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a magnetic housing member and magnetic member of the Christmas light of the present invention;

FIG. 2 illustrates a magnetic housing member and magnetic member of the present invention;

FIG. 3 illustrates a string of Christmas lights of the present invention;

FIG. 4 illustrates a top view of the magnetic housing member of the Christmas light of the present invention;

FIG. 5 illustrates a bottom view of the magnetic housing member of the Christmas light of the present invention.

### DETAILED DESCRIPTION

The present invention provides a method and apparatus for easily installing and removing Christmas lights which may be arranged in a string of Christmas lights by interconnecting wires. Although the present invention is described in terms of Christmas lights, other lights having a string of lights whether used for Halloween and a birthday or any other occasion are within the scope of the present invention. The individual lights of the string of Christmas lights are detachably connected magnetically to the house or establishment in order to easily install and removes the Christmas lights. The magnetic connection provides a convenient and secure connection to the house or establishment, yet allows the Christmas lights to be easily removed. The teachings of the present invention can be applied to any surface which is magnetic magnetically attracted to the magnets associated with the Christmas lights of the present invention. The magnets may attach to the eaves a house having metal flashing. The present invention may be used on various types of devices and vehicles, for example on vehicles for decoration (such as parades), metal ceiling grids in class rooms, on garage doors, on metal patio covers, on metal hand rails, on metal joists in building with no ceiling tiles, on metal windows, on door frames, on metal fencing or gates for night time lighting or decoration, on metal roofs (non-commercial). on business roofing for signage lighting or to be noticed or other such objects.

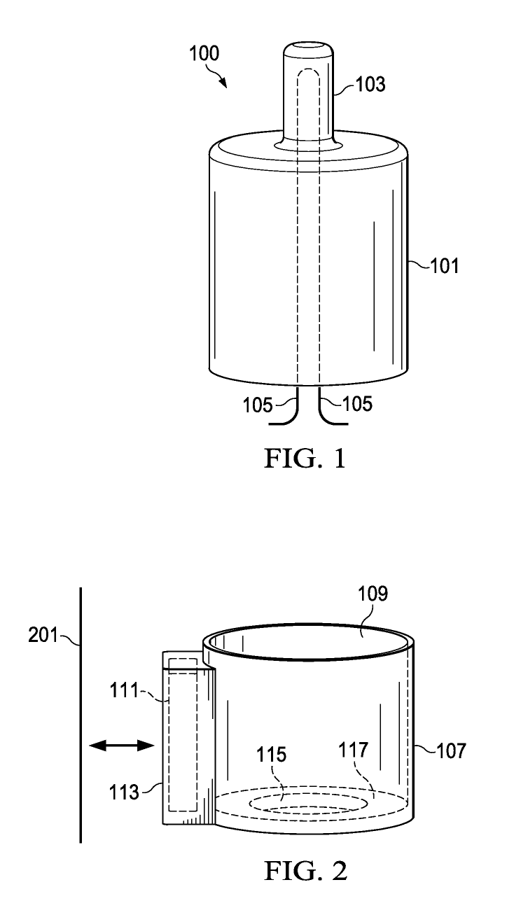

FIG. 1 illustrates a side view of a Christmas light 100 which may include a light base member 101 for mounting a light filament member 103 which may be operable to turn on and off to provide a light of varying colors. The light filament member 103 may be connected to a pair of wire members 105 to provide electrical connection to the light filament member 103 and which extends through the Light base member 101. The light filament member 103 may be formed from glass or other appropriate material, and the light base member 101 may be formed from plastic or other suitable material. The light base member 101 may be elongated in shape.

FIG. 2 illustrates a magnetic housing member 107 which may be formed to cooperate with the light base member 101 and which may be formed from a sheet of a heat shrinkable material in order to provide a friction fit with the light base member 101. The magnetic housing member 107 may be connected to the light base member 101 by adhesive or other suitable material. The sheet of heat shrinkable material which may be planar, cylinder shaped, or other suitable shapes to cooperate with the light base member 101 may be wrapped around the light base member 101 and heat may be applied to shrink the heat shrinkable material to form the magnetic housing member 107. The magnetic housing member 107 may include an upper aperture 109 to accept the light base member 101 and may include a lower aperture 115 so that the wire member 105 may connect with the adjacent light base member 101 and to a power supply (not shown). The magnetic housing member 107 optionally may include a shoulder member 117 to define the lower aperture 115 and to support the light base member 101. The magnetic housing member 107 may include a magnet enclosure portion 113 to enclose a magnetic member 111 to attract a metallic surface 201 to support the Christmas light 100 of the present invention. The magnetic member 111 may include a round magnate, cylinder shaped magnet, square magnet, triangular magnet or any multi-shaped magnet.

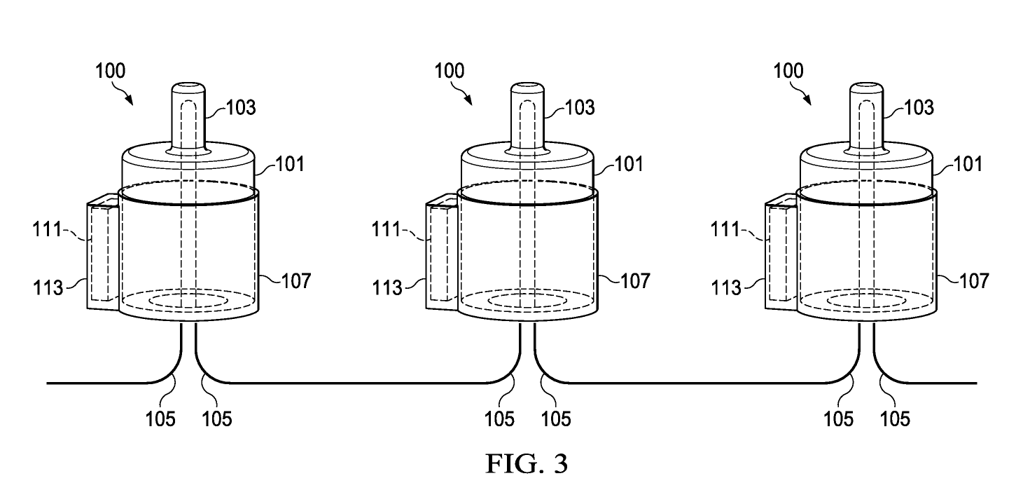

FIG. 3 illustrates a side view of a string of Christmas lights 100 which may be connected by wire member 105 in series or parallel or a combination of series and parallel to form the string of Christmas lights 100 and each of the Christmas lights 100 may include a light base member 101 for mounting the light filament member 103 which may be operable to turn on and off to provide a light of varying colors. The light filament member 103 may be connected to a pair of wire members 105 to provide electrical connection to the light filament member 103 and which extends through the light base member 101. The light base member 101 may be elongated in shape.

FIG. 3 illustrates a magnetic housing member 107 which may be formed to cooperate with the light base member 101 to provide a friction fit with the light base member 101. The sheet which may be planar, cylinder shaped or other suitable shape in order to cooperate with the light base member 101 of heat shrinkable material may be wrapped around the light base member 101 and heat may be applied to shrink the heat shrinkable material to form the magnetic housing member 107 to hold the magnet member 111 to the side or bottom of the light base member 101. The magnetic housing member 107 may include an upper aperture 109 to accept the light base member 101 and may include a lower aperture 115 so that the wire member 105 may connect with the adjacent Light base member 101 and to a power supply (not shown). The magnetic housing member 107 optionally may include a shoulder member 117 to define the lower aperture 115 and to support the Light base member 101. The magnetic housing member 107 may include a magnet enclosure portion 113 to enclose a magnetic member 111 to attract a metallic surface to support the Christmas light 100 of the present invention. The magnetic member 111 may include a round magnate, cylinder shaped magnet, square magnet, triangular magnet or any multi-side shaped magnet.

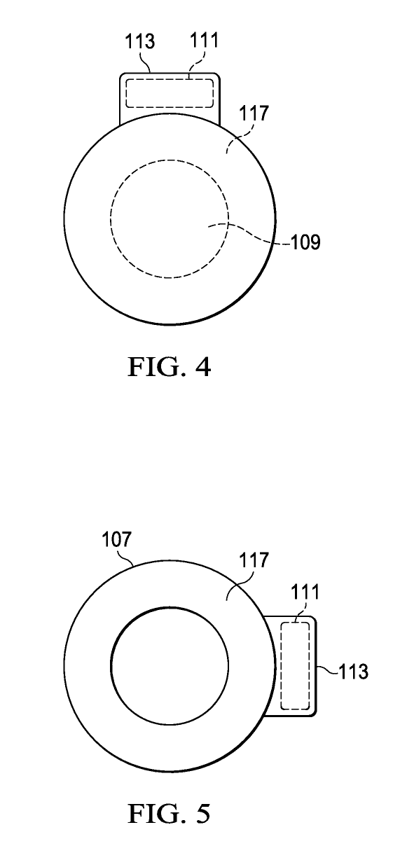

FIG. 4 illustrates a top view of the magnetic housing member 107 of the Christmas light 100, and FIG. 4 shows the magnetic member 111, the upper aperture 109 and the shoulder member 117.

FIG. 5 illustrates a bottom view of the magnetic housing member 107 of the Christmas light 100, and FIG. 4 shows the magnetic member 111, the upper aperture 109 and the shoulder member 117.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A string of detachably connected lights, comprising
a first light being magnetically detachably connected to a magnetic surface;
a second light being magnetically detachably connected to the magnetic surface and being electrically connected to the first light.

2. A string of detachably connected lights as in claim 1, wherein the first light includes a first filament.

3. A string of detachably connected lights as in claim 1, wherein the second light includes a second filament.

4. A string of detachably connected lights as in claim 1, wherein a second light includes a second light base member.

5. A string of detachably connected lights as in claim 1, wherein the first light includes a first magnetic housing member.

6. A string of detachably connected lights as in claim 1, wherein the second light includes a second housing member.

7. A string of detachably connected lights as in claim 5, wherein the first housing member includes a first magnetic enclosure portion.

8. A string of detachably connected lights as in claim 6, wherein the second magnetic housing member includes a second magnetic enclosure portion.

9. A string of detachably connected lights as in claim 7, wherein the first magnetic housing member includes a first magnet.

10. A string of detachably connected lights as in claim 8, wherein the second magnetic housing member includes a second magnet.

11. A string of detachably connected lights as in claim 5, wherein the first magnetic housing member is heat shrunk.

12. A string of detachably connected lights as in claim 6, wherein the second magnetic housing member is heat shrunk.

13. A string of detachably connected lights as in claim 1, wherein the first light includes a first light base member.
